(19) United States
(12) Patent Application Publication
(10) Pub. No.: US 2020/0191679 A1
(43) Pub. Date: Jun. 18, 2020

(54) ANTI-LEAK FLANGED JOINT STRUCTURE WITH DETECTION AND EARLY WARNING FUNCTION, AND PIPE JOINT LEAKAGE PREVENTION DEVICE USING THE SAME

(71) Applicant: JUEI-LIU WANG, TAINAN CITY (TW)

(72) Inventor: JUEI-LIU WANG, TAINAN CITY (TW)

(21) Appl. No.: 16/518,077

(22) Filed: Jul. 22, 2019

(30) Foreign Application Priority Data
Dec. 13, 2018 (TW) 107216939

(51) Int. Cl. G01M 3/00; F16L 23/032

(52) U.S. Cl. CPC G01M 3/00; F16L 2201/30; F16L 23/032

(57) ABSTRACT

An anti-leak flanged joint structure with a detection and early warning function is disclosed along with a pipe joint leakage prevention device using the same. The anti-leak flanged joint structure includes a first and a second flange plate, a gasket, and a leakage sensor. The first flange plate includes a first fixing plate with a cavity. The gasket lies in the cavity without jutting out. The second flange plate includes a second fixing plate with a peripheral recessed portion. The second fixing plate lies in and closes the cavity, forming a receiving space between the recessed portion and the wall of the cavity. Any working fluid leaking at the joint between the flange plates will be stored in the receiving space against evaporation into the air and sensed by the leakage sensor, which either alerts the maintenance personnel or signals a processor to turn off the associated motor.

### BACKGROUND OF THE INVENTION

### 1. Technical Field

The present invention relates to an anti-leak flanged joint structure with a detection and early warning function, and to a pipe joint leakage prevention device using the same. More particularly, the invention relates to a flanged joint structure with a receiving space formed by the cavity and recessed portion of two opposing flange plates so that any working liquid leaking at the butt joint formed by the flange plates will be temporarily stored in the receiving space and sensed by a leakage sensor.

### 2. Description of Related Art

Two connected pipes are generally secured to each other with flanges, or more specifically with a first flange plate, a second flange plate, and an anti-leak gasket between the flange plates. Moreover, a fluid to be conveyed through a pipe system is typically driven by a motor and is drawn into the system via an inlet pipe and discharged via an outlet pipe.

When the fluid to be drawn is an industrial fluid, such as a highly acidic liquid (e.g., sulfuric acid) for use in a battery electrolyte, a low-flash-point flammable vapor (e.g., acetone or acetophenone), or a hazardous (e.g., toxic) solvent, it is imperative to provide the inlet pipe with a valve for the sake of safety, and the valve is in most cases away from the motor switch. To draw such a fluid (e.g., a highly acidic liquid) into the pipe system safely, the first step is to open the valve, and then the inlet pipe is brought into communication with the acid tank, before the motor is turned on to draw the liquid acid into the pipe system. As the motor switch is away from the valve, the operator is protected from being splashed with the highly acidic, and hence corrosive, liquid should the pressure in the pipe system become too high. More specifically, when the motor rotates at high speed but the valve is not opened sufficiently, or when the bolts used to secure the first and the second flange plates come loose due to vibration, there will be a pressure difference that tends to drive the acidic liquid out of the pipe system through the joint between the first and the second flange plate (typically through the gap formed around the anti-leak gasket between the flange plates). If the acidic liquid is splashed onto and contacts the operator's body, physical injury will ensue. If, on the other hand, a low-flash-point organic solvent leaks and evaporates into the air, explosion may take place when the concentration of the solvent vapor reaches a certain level. Such explosion not only causes property damage, but may also contaminate the air, soil, and water source in the affected area, if not taking the lives of those directly involved or affected. Take the recent explosion in Changchun, Jilin Province of China for example (https://hk.news.appledaily.com/china/realtime/article/20190130/59203716). Gas leak occurred in a residence in the Luyuan District of Changchun at about 5 o'clock in the morning, and the resulting explosion and fire killed eight and wounded three. Since the leakage of any working fluid tends to have catastrophic consequences, a leaking pipe raises serious industrial safety issues.

To prevent a working fluid from bursting a flanged pipe joint, Taiwan Patent No. M533714 discloses an “anti-leak device for a flanged joint”, wherein the anti-leak device includes a first enclosing member and a second enclosing member to be secured around a flanged joint; Taiwan Patent No. M428288 discloses a “leakage prevention cover for a flanged joint”, wherein the leakage prevention cover includes a band-like body to be wrapped around a flanged joint; Chinese Patent Application No. 201803019 discloses a “flanged joint safety cover” to be mounted around a flanged joint; and Chinese Patent Application No. 204533907 discloses a “plastic anti-splash band for a flanged joint”, wherein the anti-splash band is also mounted around a flanged joint.

It can be known from the afore-cited patent documents that one typical method to prevent a working fluid from leaking through a flanged joint is to wrap an anti-leak member around the joint. The additional anti-leak member, however, incurs extra cost, takes up additional space, and adds to the difficult of assembly.

Moreover, when a working fluid does leak, the additional anti-leak member may fail to contain the working fluid if there is an excessively large pressure difference; in other words, leakage into the air may occur despite the anti-leak member. If the leaking working fluid has a relatively low flash point, the risk of explosion at a certain vapor concentration still exists.

Traditionally, whether the working fluid in a pipe system leaks is known by detecting the fluid pressure in the pipes. When a pressure drop is detected, each pipe in the system must be inspected in order to locate and fix the leaking spot. However, this leakage detection method is so labor-intensive and time-consuming that, if the working fluid in question is explosive, an industrial safety incident may still occur. An alternative method is to mount a leakage sensor outside each flanged joint, but such an external leakage sensor works only when a major leak has occurred, meaning the severity of leakage-related hazards will be increased instead.

### BRIEF SUMMARY OF THE INVENTION

In view of the above, the inventor of the present invention aims to provide an anti-leak flanged joint structure having a detection and early warning function so that, without having to resort to additional means, a working fluid is kept from leaking out of or bursting a flanged pipe joint. The anti-leak flanged joint structure with a detection and early warning function includes a first flange plate, a gasket, a second flange plate, and a leakage sensor.

The first flange plate includes a first opening and a first fixing plate. The first fixing plate is concavely provided with a cavity that extends in the axial direction of the first opening. The gasket is placed in the cavity and does not jut out of the cavity. The second flange plate includes a second opening and a second fixing plate. The second fixing plate is peripherally provided with a recessed portion and is placed in the cavity of the first fixing plate to close the cavity. Once the second fixing plate is locked to the first fixing plate, the second flange plate is connected to the first flange plate, the first opening is in communication with the second opening, and a receiving space is formed by the recessed portion of the second fixing plate and the wall of the cavity of the first fixing plate. The leakage sensor is configured to sense any working fluid that leaks into the receiving space.

Preferably, a fixing member is passed through the first fixing plate and the second fixing plate to press the two fixing plates tightly together.

Preferably, the first fixing plate is provided with a through hole in communication with the receiving space.

Preferably, a guide tube is connected to the first fixing plate and in communication with the through hole.

Preferably, the leakage sensor is provided in a surrounding area of the through hole. More preferably, the leakage sensor is provided in the receiving space.

Preferably, the periphery of the first fixing plate of the first flange plate forms a first inclined surface, and the periphery of the second fixing plate of the second flange plate forms a second inclined surface. When the second flange plate is connected to the first flange plate, the second inclined surface lies flat against the first inclined surface to form a closed inclined surface.

The present invention also provides a pipe joint leakage prevention device that uses the aforesaid anti-leak flanged joint structure with a detection and early warning function. The pipe joint leakage prevention device includes a processor, a motor, and at least one pipe, in addition to the anti-leak flanged joint structure with a detection and early warning function.

The anti-leak flanged joint structure with a detection and early warning function is connected between the motor and one pipe or between two adjacent pipes. The processor is signal-connected to the leakage sensor of the anti-leak flanged joint structure and the motor. When the leakage sensor senses a leak and generates a corresponding leakage signal, the processor turns off the motor in response to the leakage signal.

The foregoing technical features can produce the following effects:

1. Since no additional component is required for producing the intended anti-leak effect, the anti-leak flanged joint structure of the present invention does not incur additional cost, does not take up extra space, and can be assembled in the same way, and as easily, as an existing flanged joint.

2. Any working fluid leaking at a pipe joint constructed according to the invention will be temporarily stored in the receiving space to reduce the risk of explosion resulting from the leaking working fluid evaporating into the air.

3. Now that the leakage sensor is used to sense the leakage of a working fluid, the location of a leaking spot can be known from the leakage sensor without having to inspect the entire pipe system.

4. As the processor can turn off the motor immediately upon receiving the leakage signal, continued leakage is prevented to ensure the safety of working fluid transfer.

5. As the leakage sensor is provided in the receiving space formed by butt-joining the first and the second flange plates, any leakage at a joint constructed according to the invention will be sensed before the leaking working fluid flows out of the joint. Consequently, the severity as well as occurrence of leakage-related hazards is reduced.

6. Once the second flange plate is butt-joined to the first flange plate, the closed inclined surface formed by the second inclined surface lying flat against the first inclined surface provides increased tightness and additional resistance that prevent any leaking working fluid from gushing out of the butt joint between the first and the second flange plates.

### BRIEF DESCRIPTION OF THE SEVERAL VIEWS OF THE DRAWINGS

FIG. 1 is an exploded perspective view of an embodiment of the present invention;

FIG. 2 is an assembled perspective view of the embodiment shown in FIG. 1;

FIG. 3 is a sectional view of the embodiment shown in FIG. 2;

FIG. 4 shows an application of the embodiment shown in FIG. 1 to FIG. 3;

FIG. 5 shows an embodiment of the invention in which the leakage sensor is a sensing coil extending in and along the receiving space; and

FIG. 6 shows an embodiment of the invention in which the second inclined surface lies flat against the first inclined surface to form a closed inclined surface when the second flange plate is connected to the first flange plate.

### DETAILED DESCRIPTION OF THE INVENTION

The present invention incorporates the aforesaid technical features into an anti-leak flanged joint structure with a detection and early warning function and a pipe joint leakage prevention device using the same, whose major effects are demonstrated by the following embodiments.

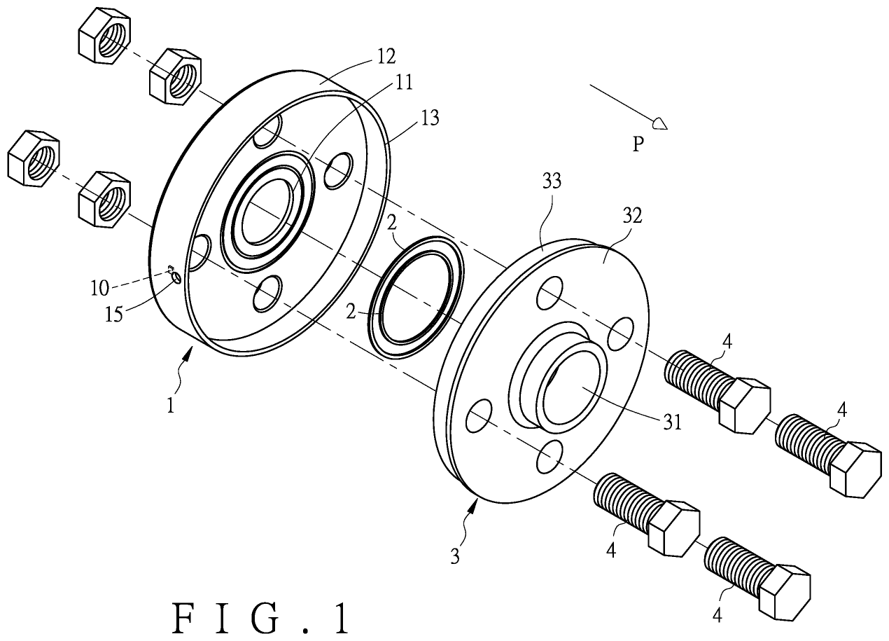

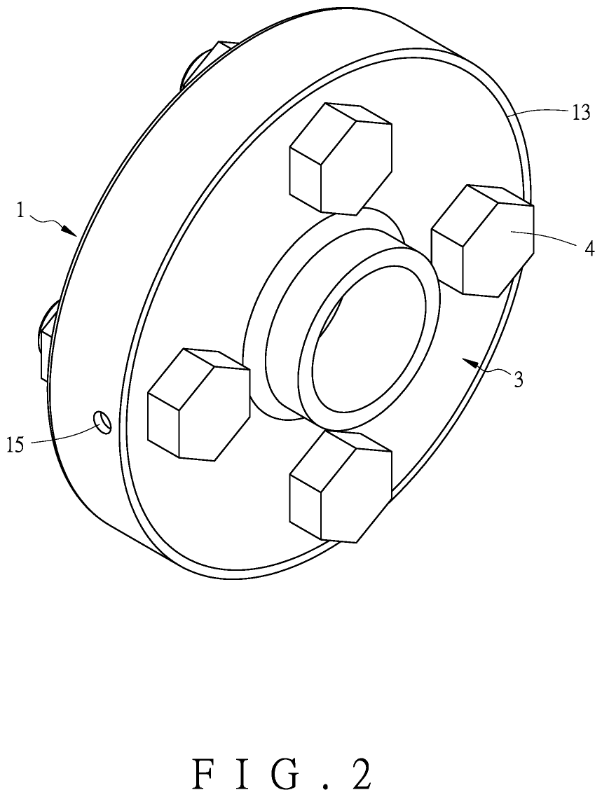

Referring to FIG. 1 to FIG. 3, one embodiment of the present invention includes a first flange plate 1, a gasket 2, a second flange plate 3, and a leakage sensor 10.

The first flange plate 1 includes a first opening 11 and a first fixing plate 12. The first fixing plate 12 is concavely provided with a cavity 13 that extends in the axial direction P of the first opening 11.

The gasket 2 is placed in the cavity 13 without jutting out of the cavity 13.

The second flange plate 3 includes a second opening 31 and a second fixing plate 32, wherein the second fixing plate 32 is peripherally provided with a recessed portion 33. The second fixing plate 32 of the second flange plate 3 is placed in the cavity 13 to close the cavity 13, before a fixing member 4 is passed through the first fixing plate 12 and the second fixing plate 32 to press the first fixing plate 12 and the second fixing plate 32 tightly together and thereby connect the second flange plate 3 to the first flange plate 1. Once the two flange plates are connected, the first opening 11 and the second opening 31 are in communication with each other, and the recessed portion 33 of the second flange plate 32 and the wall of the cavity 13 of the first fixing plate 12 jointly form a receiving space A. The first fixing plate 12 is further provided with a through hole 15 in communication with the receiving space A.

The leakage sensor 10 is provided in the receiving space A and is adjacent to an edge of the through hole 15.

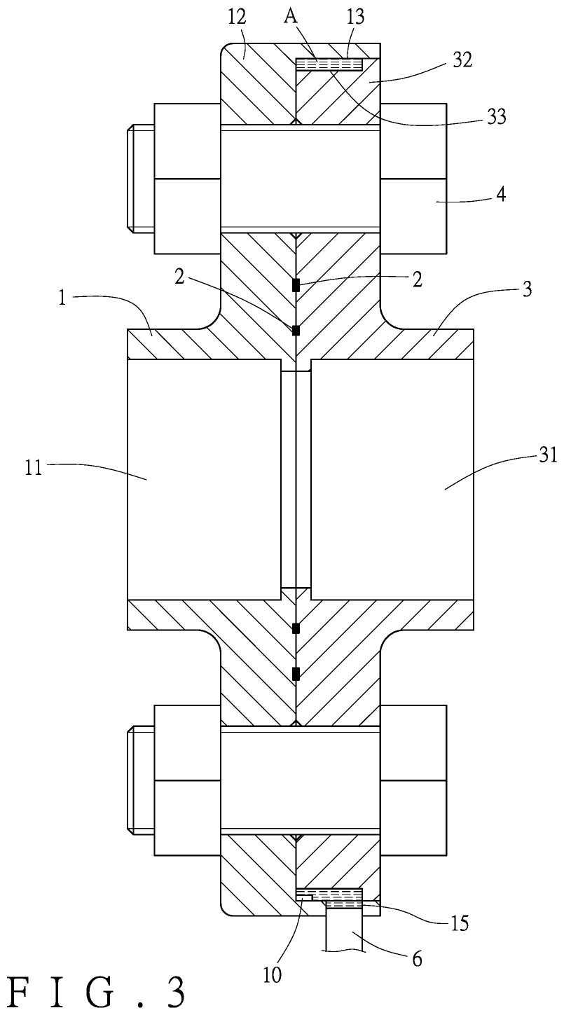

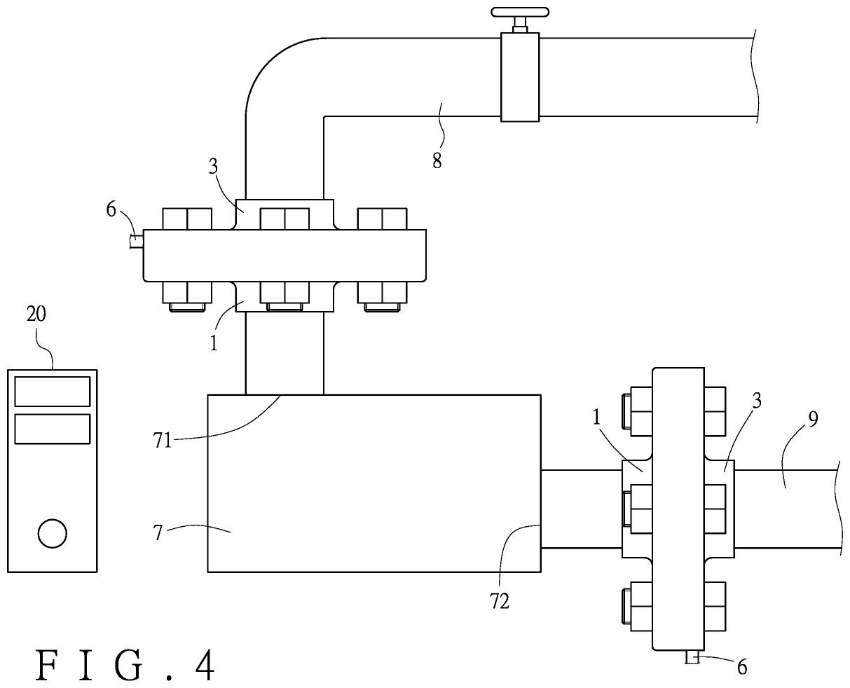

FIG. 4 shows the present invention applied to a pipe system in which a motor 7 is used to draw an industrial fluid into the system, and which includes two flanged joints constructed according to the invention. One of the flanged joints has its first flange plate 1 connected to the inlet end 71 of the motor 7 and its second flange plate 3 connected to an inlet pipe 8. The other flanged joint has its first flange plate 1 connected to the outlet end 72 of the motor 7 and its second flange plate 3 connected to an outlet pipe 9. Each flanged joint also has a guide tube 6 connected to the first fixing plate 12 and in communication with the through hole 15 (as can be seen more clearly in FIG. 3). The industrial fluid can be drawn into the pipe system once the aforesaid connections are completed. It is worth mentioning that the two first flange plates 1 may be integrally formed with the motor 7.

Referring to FIG. 3 in conjunction with FIG. 4, the gasket 2 is placed into the cavity 13 of the first fixing plate 12 of the first flange 1 together with the second fixing plate 32 of the second flange plate 3. As a result, the gasket 2 is kept from exposure to the outside and can prevent the working fluid being conveyed from leaking or splashing should a pressure difference be generated or should the fixing member 4 come loose during the fluid conveying process. The receiving space A is configured to receive any working fluid that manages to escape the inlet pipe 8 or the outlet pipe 9, lest the working fluid (which may be a low-flash-point fluid) evaporate into the air and incur the risk of explosion. The working fluid in the receiving space A will be guided by the guide tube 6 into a recycling tank and, during the process, be sensed by the leakage sensor 10, which in turn notifies the maintenance personnel immediately for repair. When a pipe system includes a plurality of flanged joints constructed according to the present invention, the leakage sensors 10 in all the flanged joints may be sequentially numbered and connected to a processor 20. Thus, when any of the flanged joints leaks, the processor 20 can inform the maintenance personnel of the number of the leakage sensor 10 that generates the leakage signal, and the maintenance personnel will know the location of the leak from the number of the leakage sensor 10 without having to inspect the entire pipe system. This reduces the labor and time required for spotting a leak and consequently the probability of industrial safety incidents. The motor 7 may also be electrically connected to the processor 20 in order for the processor 20 to turn off the motor 7 as soon as a leakage sensor 10 connected to the processor 20 generates the leakage signal, thereby preventing further leak of the working fluid and increasing the safety of working fluid transfer. As the flanged joints in this embodiment do not require any additional components for producing the anti-leak effect, no additional cost is incurred, and the joints do not occupy any extra space. The absence of additional components also means that the flanged joints described above have the same assembly method, and therefore can be assembled as easily, as a common flanged joint.

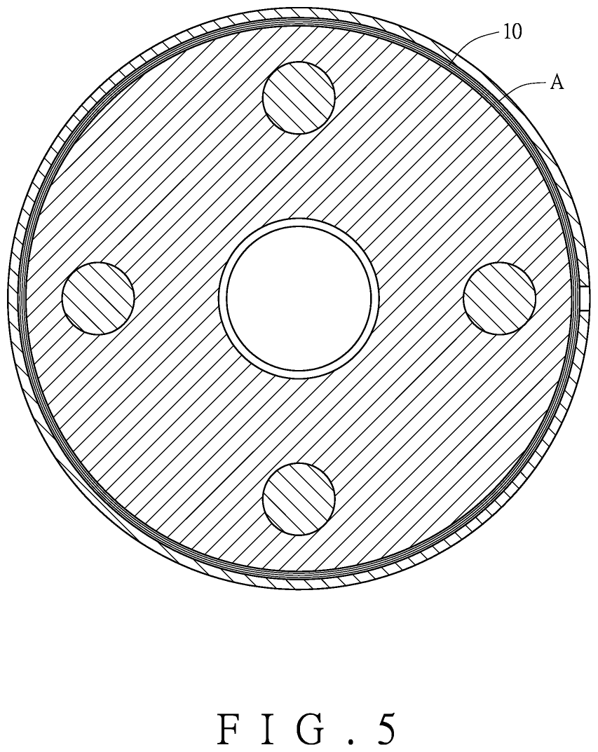

Referring to FIG. 5, the leakage sensor 10 may also be a sensing coil extending in and along the entire receiving space A in order to detect any leaking spot along the periphery of the flanged joint.

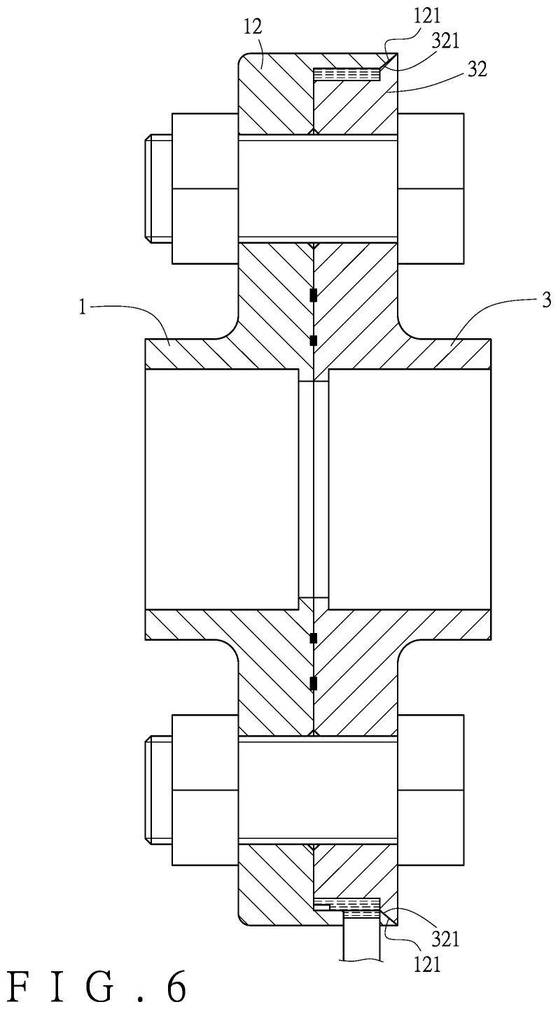

Referring to FIG. 6, the first fixing plate 12 of the first flange plate 1 may be peripherally formed with a first inclined surface 121, and the second fixing plate 32 of the second flange plate 3 may be peripherally formed with a second incline surface 321. When the second flange plate 3 is connected to the first flange plate 1, the second inclined surface 321 lies flat against the first inclined surface 121 to form a closed inclined surface, which not only increases the tightness between the second flange plate 3 and the first flange plate 1, but also generates additional resistance to prevent any leaking working fluid from gushing out of the butt joint between the two flange plates.

The embodiments described and illustrated herein should be able to enable a full understanding of the operation, use, and effects of the present invention. Those embodiments, however, are only some preferred ones of the invention and are not intended to be restrictive of the scope of the invention. All simple equivalent changes and modifications based on the appended claims and the present disclosure should fall within the scope of the invention.

What is claimed is:

1. An anti-leak flanged joint structure with a detection and early warning function, connected to at least one pipe for conveying a working fluid, the anti-leak flanged joint structure comprising:
a first flange plate comprising a first opening and a first fixing plate, wherein the first fixing plate is concavely provided with a cavity extending in an axial direction of the first opening;
a gasket placed in the cavity without jutting out of the cavity;
a second flange plate comprising a second opening and a second fixing plate, wherein the second fixing plate is peripherally provided with a recessed portion, the second fixing plate is placed in the cavity to close the cavity, and the second fixing plate is locked to the first fixing plate such that the second flange plate is connected to the first flange plate, with the first opening and the second opening in communication with each other, and with the recessed portion of the second fixing plate and a wall of the cavity jointly forming a receiving space; and
a leakage sensor for sensing any said working fluid leaking into the receiving space.

2. The anti-leak flanged joint structure with the detection and early warning function as claimed in claim 1, further comprising a fixing member passed through the first fixing plate and the second fixing plate to press the first fixing plate and the second fixing plate tightly together.

3. The anti-leak flanged joint structure with the detection and early warning function as claimed in claim 1, wherein the first fixing plate is provided with a through hole in communication with the receiving space.

4. The anti-leak flanged joint structure with the detection and early warning function as claimed in claim 3, further comprising a guide tube connected to the first fixing plate and in communication with the through hole.

5. The anti-leak flanged joint structure with the detection and early warning function as claimed in claim 3, wherein the leakage sensor is provided in a surrounding area of the through hole.

6. The anti-leak flanged joint structure with the detection and early warning function as claimed in claim 5, wherein the leakage sensor is provided in the receiving space.

7. The anti-leak flanged joint structure with the detection and early warning function as claimed in claim 1, wherein the leakage sensor is a sensing coil extending in and along the receiving space.

8. The anti-leak flanged joint structure with the detection and early warning function as claimed in claim 1, wherein the first fixing plate of the first flange plate is peripherally formed with a first inclined surface, the second fixing plate of the second flange plate is peripherally formed with a second inclined surface, and when the second flange plate is connected to the first flange plate, the second inclined surface lies flat against the first inclined surface to form a closed inclined surface.

9. A pipe joint leakage prevention device using the anti-leak flanged joint structure with the detection and early warning function as claimed in claim 1, comprising:
the anti-leak flanged joint structure with the detection and early warning function;
a processor;
a motor; and
at least one pipe;
wherein the anti-leak flanged joint structure with the detection and early warning function is connected between the motor and a said pipe or between two adjacent said pipes, and the processor is signal-connected to the leakage sensor of the anti-leak flanged joint structure with the detection and early warning function and the motor in order to turn off the motor as soon as the leakage sensor senses any said working fluid leaking into the receiving space.
